(19) United States
(12) Patent Application Publication
(10) Pub. No.: US 2006/0078117 A1
(43) Pub. Date: Apr. 13, 2006

(54) Method of providing A/V telecommunications to consumers

(76) Inventor: J. Hutton Pulitzer, Addison, TX (US)

Correspondence Address: JACKSON WALKER LLP, 2435 NORTH CENTRAL EXPRESSWAY, SUITE 600, RICHARDSON, TX, 75080, US

(21) Appl. No.: 11/184,034

(22) Filed: Aug. 3, 2004

(51) Int. Cl. H04N 7/167

(52) U.S. Cl. 380/211; 725/112

(57) ABSTRACT

Audio-visual telecommunications are provided to consumers by identifying a consumer and providing an information appliance comprising a network connection, a telecommunications processor connected to the network connection, and a video processor connected to the network connection. Audio-visual content is provided to the information appliance and fees are collected from an audio-visual content provider.

### TECHNICAL FIELD OF THE INVENTION

The invention relates to the field of video telephony, in particular to an integrated multi-network video telephones.

### BACKGROUND OF THE INVENTION

The combination of video and audio channels provide a unique platform for interpersonal communication. With the availability of broadband Internet network connections in the home, there is an opportunity to provide further methods of interaction between content providers and consumers.

What is needed, therefore, is a system and method of providing a broadband information appliance.

### SUMMARY OF THE INVENTION

Audio-visual telecommunications are provided to consumers by identifying a consumer and providing an information appliance comprising a network connection, a telecommunications processor connected to the network connection, and a video processor connected to the network connection. Audio-visual content is provided to the information appliance and fees are collected from an audio-visual content provider.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a household broadband information appliance;

FIG. 1A illustrates a handset for a household broadband information appliance;

FIG. 2 illustrates a block diagram of a household broadband information appliance;

FIG. 3 illustrates a block diagram of a household broadband information appliance; and

FIG. 4 illustrates a flowchart for a method of providing A/V telecommunications to a consumer.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

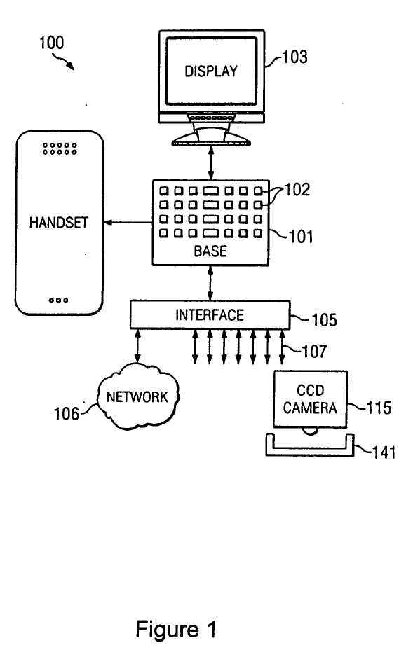

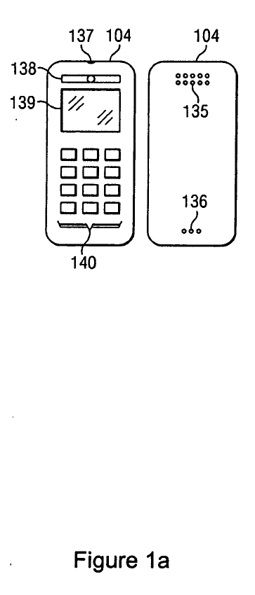

With reference to FIG. 1, a functional depiction of a broadband information appliance 100 is shown. The broadband information appliance 100 includes a base unit 101. The base unit 101 typically houses the processing circuits, memory storage, interfaces 105, manual inputs 102 and power connections. The base unit 101 may be attached to a display 103. The display 103 may be integral with the base unit 101. The display 103 may be an independent unit fixedly attached to the base unit 101. The display 103 may be interchangeably attached to the base unit 101 such that the display 103 may be easily exchanged for a different display 103.

Base unit 101 may include manual inputs 102. Typically the manual inputs 102 may include a standard telephone keypad with ten numeric buttons plus “#” and “*” buttons. The manual inputs 102 may further include any number of other buttons, switches, thumbwheels or other appropriate manual input devices. A wide variety of functions and features may be controlled using the manual inputs 102. Manual inputs 102 may include navigation keys or a joystick for up, down, right and left selections, programmable soft keys. Power and status LEDs may also be provided.

Base unit 101 may be connected to a handset 104. Handset 104 may be substantially a standard telephone handset including a microphone and speaker. Handset 104 may be directly connected to the base unit 101. A handset 104 directly connected to the base unit 101 may be called a “tethered” or “wired” handset. Handset 104 may also include a wireless transceiver for wireless connection to a base unit including (or connected to) a wireless transceiver. The wireless transceivers may be a 2.4 gigahertz transceivers or may use any other suitable wireless transceiver frequency. The wireless transceivers may be spread spectrum transceivers. A handset 104 wirelessly connected to the base unit may be called a “wireless” handset.

Base unit 101 may be connected to an interface 105. Typically, interface 105 will be integral with base unit 101. Interface 105 includes an interface for connection to network 106. Network 106 may be an open network such as the Internet. Interface 105 includes interface connections 107 for connecting the base unit 101 to a variety of peripherals or networks. Typically, the interface 105 will provide Ethernet ports, telephone handset and keypad support, video capture and display ports including NTSC composite input and output ports, S-video ports, NTSC camera ports and LCD display ports. The interface 105 may include audio capture and reproduction ports, an external microphone port, an external speaker port, two audio line level inputs, a handsfree speakerphone,

A digital video camera 115 may be connected to base unit 101. Typically digital video camera 1105 is a CCD camera device. The digital video camera 115 may be integral with the base unit 101 or the display 103. An additional digital video camera 137 may be integral with the handset 104. A privacy shield 141 may be a cover provided to disable the digital video camera 137 by covering the lens of the digital video camera 137.

With reference to FIG. 1A, a more detailed depiction of the features that may be incorporated into handset 104 is shown. The handset 104 typically includes a speaker 135 and a microphone 136 to provide standard audio communication. Handset 104 may include a digital video camera 137, typically at one end of the handset 104. A scanner 138 may be provided on the handset 104 to read machine readable codes or to scan image data. An LCD display 139 may be provided on the handset 104 to allow the user to see the input from digital video camera 137, show video data being shown on display 103 when the handset 104 is being used remotely from the base 101. The handset display 139 may also show alternate visual data. The handset 104 may include further manual inputs 140 to control the video camera 137, handset display 139, scanner 138.

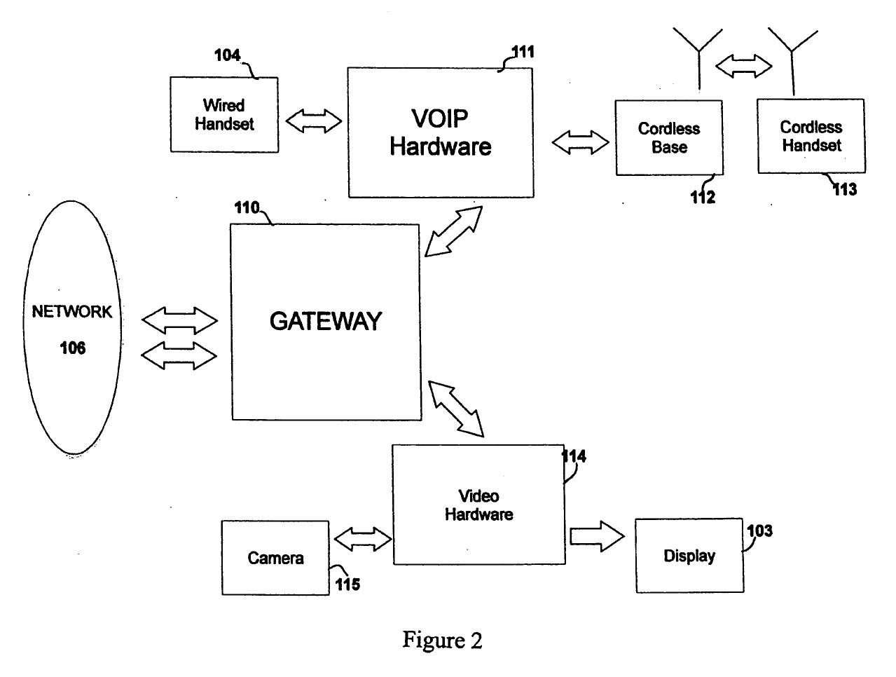

With reference to FIG. 2, a functional block diagram of a basic broadband information appliance 100 is shown. A gateway 110 provides an interface to network 106. The gateway communicates with voice-over-internet-protocol (VOIP) hardware 111 and video hardware 114. The VOIP hardware 114 may be directly connected to wired handset 104 or may be connected to a cordless base unit 112 which provides wireless communication with a cordless handset 113. The video hardware 114 may be connected to a video camera 115 and a display 103.

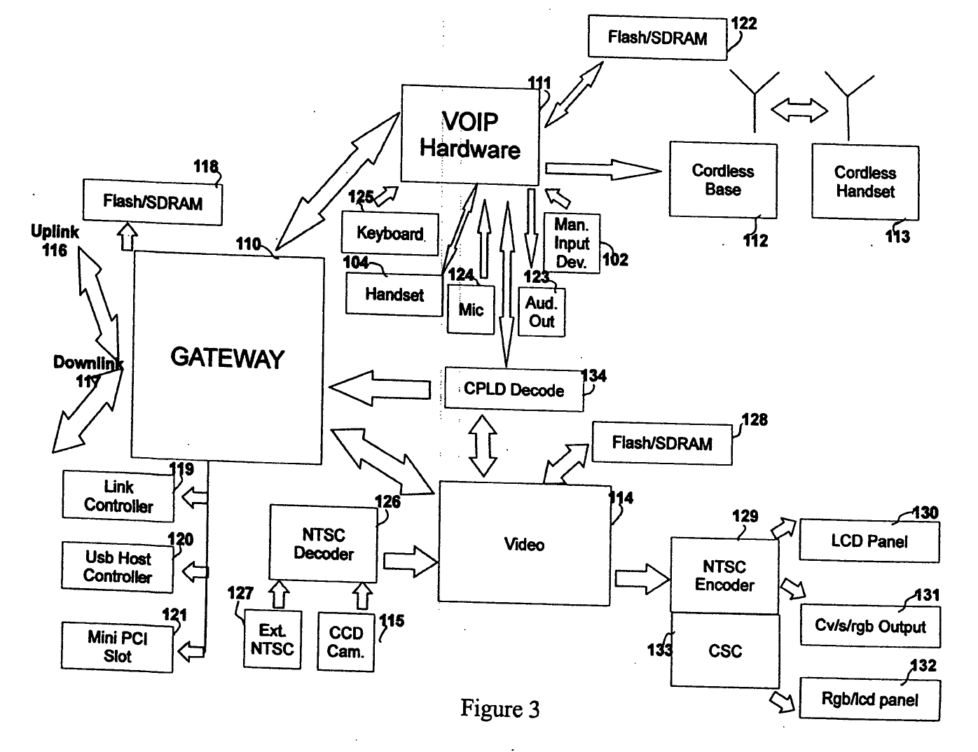

With reference to FIG. 3, a more detailed functional block diagram of a broadband information appliance 100 is shown. A gateway 110 provides communication with one or more networks 106. Gateway 110 may be a Micrel KS8695P processor. The gateway 110 typically acts as the master boot processor for the broadband information appliance 100. The gateway 110 is typically an integrated, multi-port PCI bridge system on a chip. The KS8695P integrates an ARM922T CPU, a PCI bridge that can support up to 3 external PCI masters and a 5-port switch with integrated media access controllers and low power Ethernet PHYs. The PCI interface can be connected gluelessly to miniPCI or cardbus wireless LAN cards that support 802.11a/g/b. Those skilled in the art will recognize that other processors, chips or configurations could be used for the gateway 110.

The KS8695P gateway processor includes five Ethernet MAC and PHY, 10/100 Base-Transceivers. It includes a PCI bridge and Master arbiter of up to 3 external PCI 2.1 compliant controllers, supporting a 32 bit data bus as 33 MHz clock speed. The processor includes a memory controller for glueless synchronous DRAM support at 133 MHz access of up to 32 MB. The processor has a standard memory bus for SRAM and flash ROM, 32 bit address, 32 bit data up to 32 MB, with general purpose I/O pins and a JTAG port.

Gateway 110 provides one or more external Ethernet ports. Gateway 110 includes Ethernet ports for both uplink 116 and downlink 117 connections. Typically, uplink 116 and downlink 117 are integrated, however according to some embodiments, separate communication links may be provided for the uplink 116 and downlink 117, particularly where bandwidth limitations make it advisable to provide greater bandwidth for the downlink 117 than the uplink 116.

Gateway 119 may be connected to a link controller 119, a USB host controller 120, a mini-PCI slot 121 or other interfaces. Gateway 119 may be connected to gateway memory 118. Gateway memory 118 may be flash memory, SDRAM or other suitable memory device.

Gateway 119 may be connected to a VOIP processor 111. A VOIP processor 111 is a communication processor for audio codec and telephone management. The VOIP processor 11 may be a Telogy TNETV1050 DSP. The VOIP processor may include a MIPS32 reduced instruction set computer processor and a C55 DSP. The RISC processor software supplies overall system services and performs user interface, network management, protocol stack management, call processing and task scheduling functions. The DSP software provides real-time voice processing functions such as echo cancellation, compression, pulse-code modulation data processing and tone generation and detection.

Two 10/100 Base-T Ethernet MAC and PHY are included with integrated layer-2 three-port Ethernet switches. On-chip peripherals include an 8×8 keypad interface, USB controller host, universal asynchronous receiver/transmitter serial interface, a programmable serial port, several general-purpose input/outputs and integrated voltage regulator.

The integrated dual channel 16-bit voice coder/decoder integrates the critical functions needed for IP phone applications, including two analog-to-digital converters and two digital to analog converters. Other features include analog and digital sidetone control, filter, programmable gain options, a programmable sampling rate, 8-speaker driver, microphone, handset and headset interfaces.

The VOIP processor 111 may include dual Ethernet MAC and PHY, 10/100 base transceivers. The VOIP processor 111 may include a speaker and microphone for handset, headset, and optional input and output sources. The VOIP processor 111 may include a PC and Palm compatible IrDA transceiver, a RS-232 serial port, a USB host port, general purpose I/O pins for LED and configuration options. The VOIP processor 111 may include synchronous DRAM, 133 MHz up to 128 MB, a standard memory bus, a JTAG port and HP Logic analyzer connectors. Those skilled in the art will recognize that other VOIP processors may be used as suitable.

VOIP processor 111 may be connected to a VOIP memory 112. VOIP memory 112 may be a flash memory, SDRAM or other suitable memory devices. The VOIP hardware 111 may be connected to a handset 104 or a cordless base 112 which provides wireless communication with a cordless handset 113. The VOIP hardware 111 may be connected to manual input devices 102, a microphone 124, a speaker 123. VOIP hardware 111 may be connected to an alpha-numeric keyboard 125.

Gateway 110 may be connected to video processor 114. The video processor 114 is a video codec and LCD panel controller. The VOIP processor 111 may be a TI TMS320DM642 digital signal processor. The digital signal processor may be based on the second-generation high-performance advanced VelociTI very-long-word-instruction (VLIW) architecture. The digital signal processor may provide 4800 million instructions per second at a clock rate of 600 MHz. The DSP offers operational flexibility of high speed controllers and the numerical capability of array processors. A DSP core processor has 64 general purpose registers of 32-bit word length and eight independent functional units including two multipliers for 32 bit word length and six arithmetic logic units. The DSP provides extensions in the eight functional units including new instructions to accelerate performance in video and imaging applications to extend parallelism. The DSP can produce four 32-bit multiply accumulates per cycle for a total of 2400 million MACs per second or eight 8-bit MACs per cycle for a total of 4800 million MACs. The DSP may have application specific hardware logic, on-chip memory and additional on-chip peripherals.

The DSP typically uses a two-level cache-based architecture. A Level 1 program cache is a 128-Kbit direct mapped cache and a Level 1 data cache is a 128-Kbit 2-way set-associative cache. A Level 2 memory cache consists of a 2-Mbit-memory space that is shared between program and data space. Level 2 memory can be configured as mapped memory.

The peripheral set may include configurable video ports; a 10/100 Mb/s Ethernet MAC; a management data input/output; a VCXO interpolated control port; a multichannel buffered audio serial port; an inter-integrated circuit bus module; two multichannel buffered serial ports; three 32-bit general purpose timers; a user-configurable 16-bit or 32-bit host port interface; a peripheral component interconnect; a 16-ping general-purpose input/output port with programmable interrupt/even generation modes; and a 64-bit glueless external memory interface which is capable of interfacing to synchronous and asynchronous memories and peripherals.

The DSP may have three configurable video port peripherals. These video port peripherals provide a glueless interface to common video decoder and encoder devices. The DSP video port peripherals support multiple resolutions and video standards. The video ports peripherals are configurable and can support video capture and video display modes. Each video port may include two channels with a 5120 byte capture/display buffer that is split-able between the two channels.

The DSP may include three video ports including a capture port interfaced with a Philips SAA7115 decoder with integrated multiplexer for NTSC, S-video sources; display port interfaced with Philips SAA7105 NTSC and S-video encoder and a third port dedicated to an LCD panel. The DSP may include Ethernet MAC 10/100 Base-Transceivers. The DSP may include general purpose I/O pins and a JTAG port. The DSP may be a synchronous DRAM 64-bit wide, 133 MHz up to 1 GB support. The DSP may include a standard asynchronous memory bus 32 bit. The DSP may include HP logic analyzer connectors for memory bus address, data and control signals. Those skilled in the art will recognize that other DSP processors may be implemented.

The video processor 114 may be connected to a video memory 128. Video memory 128 may be a flash memory, SDRAM or other suitable memory device. The video processor 114 may be connected to an video decoder 126. Video decoder 126 may be a NTSC decoder. Video decoder 126 may receive video signals from an external source 127 or a video camera 115. The video processor 114 may be connected to a video encoder 129. The video encoder 129 may be an NTSC encoder. The video encoder 129 may be integral with a CSC 133 to provide video signals to an RGB/LCD panel 132. The video encoder 129 may provide video signals to an LCD panel 130 and a CV/S/RGB output.

The gateway 110, VOIP processor 111 and video processor 114 may be mutually connected to a CPLD decoder 134.

The broadband information appliance 100 may include smart media access, an infrared transceiver, an unpowered firewire port, fast peripheral ports, a wireless interface, Bluetooth support and a HomePlug interface.

The broadband information appliance 100 may be an AC powered device, using residential power distribution of 120 VAC at 60 Hz or 230 VAC at 50 Hz. A power adapter may conver the AC power to 12 volts DC.

The broadband information appliance typically includes three memory module, particularly the gateway memory 118, the VOIP memory 122 and the video memory 128. SDRAM memory may be connected through each of the direct SDRAM interfaces in the DSP and gateway processors. SDRAM may be rated to operate at 133 MHz and terminated with discrete components. Dedicated SDRAM for each processor may be used.

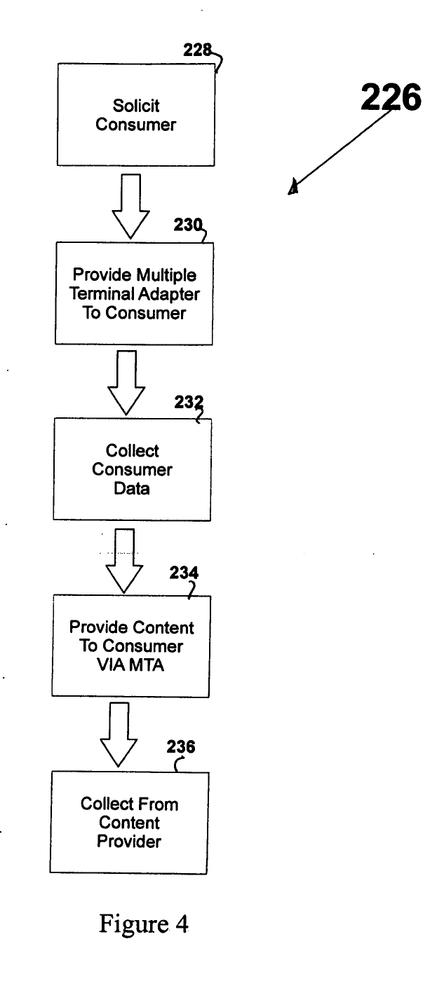

With reference to FIG. 4, a flowchart of a method of providing A/V communications to consumers 226 is shown. The household broadband information appliance 100 functions as a multiple-terminal adapter fully integrated with a telecommunications device. Customers are solicited and identified in function block 228. Each identified customer is provided with a household broadband information appliance 100 at function block 230. Typically, the hardware is provided for free in exchange for a subscription contract. It will be recognized by those skilled in the art that the household broadband information appliance 100 could be provided without cost to the consumer and without a subscription fee or contract. The household broadband information appliance collects data regarding the consumer, the consumers demographics and personal buying habits at function block 233. Audio-visual content is provided to the household broadband information appliance 100 at function block 234. The consumer data collected at function block 232 may be used to select or tailor the audio-visual content provided. The content-provider pays for access to the consumer via the household broadband information appliance at function block 236.

It will be appreciated by those skilled in the art having the benefit of this disclosure that this invention provides a broadband information appliance. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method of providing audio-visual telecommunications to consumers comprising the steps of:
identifying a consumer;
providing an information appliance comprising a network connection;
a telecommunications processor connected to the network connection; and
a video processor connected to the network connection;
providing audio-visual content to the information appliance; and
collecting fees from an audio-visual content provider.
